(19) United States
(12) Patent Application Publication
(10) Pub. No.: US 2024/0071108 A1
(43) Pub. Date: Feb. 29, 2024

(54) SYSTEMS AND METHODS FOR DETECTION OF MOBILE DEVICE USE BY A VEHICLE DRIVER

(71) Applicant: Seeing Machines Limited, Australian Capital Territory (AU)

(72) Inventor: Timothy James, Henry EDWARDS, Australian Capital Territory (AU)

(21) Appl. No.: 18/502,697

(22) Filed: Nov. 6, 2023

Related U.S. Application Data
(63) Continuation of application No. 18/559,198, filed on Jan. 1, 0001.

(30) Foreign Application Priority Data
May 5, 2021 (AU) 2021901333

(51) Int. Cl. G06V 20/59; B60W 40/08; G06V 20/56; G06V 40/18

(52) U.S. Cl. CPC G06V 20/597; B60W 40/08; G06V 20/588; G06V 40/18; B60W 2540/229

(57) ABSTRACT

Described herein is a method (1000) of detecting mobile device (400) use of a driver (102) of a vehicle (104). The method (1000) comprises the step (1001) of receiving a sequence of images of at least the driver's head captured from a camera (106, 420). At step (1002), the sequence of images are processed to determine visual attention of the driver (102) based on detected head and/or eye movements of the driver (102) over a period of time. At step (1003), mobile device use events are detected within the period of time in which a user interacts with the mobile device (400) that is located within the vehicle (104). At step (1004), a temporal correlation of the visual attention of the driver (102) with the mobile device use events is determined over the period of time. At step (1005), a determination is made that the driver (102) is using the mobile device (400) if the determined temporal correlation is greater than a threshold correlation coefficient.

### CROSS-REFERENCE TO RELATED APPLICATIONS

This application is a continuation of U.S. patent application Ser. No. 18/559,198, filed Nov. 6, 2023, which is a national stage entry under 35 U.S.C. of 371 of PCT Patent Application No. PCT/AU2022/050414, filed May 4, 2022, which claims priority to Australian Patent Application No. 2021901333, filed May 5, 2021, the entire contents of each of which are incorporated herein by reference.

### FIELD OF THE INVENTION

The present application relates to driver monitoring systems and in particular to a system and method of monitoring a driver of a vehicle.

Embodiments of the present invention are particularly adapted for detecting mobile device use by a subject in a vehicle during vehicle operation and characterizing if that subject is also driving the vehicle. However, it will be appreciated that the invention is applicable in broader contexts and other applications.

### BACKGROUND

A potential cause of vehicle accidents is the driver being distracted from the driving task. As mobile devices have increased in sophistication and market penetration, the rate of accidents believed to be caused by drivers that are distracted by mobile devices in particular are trending upwards. Of note, is that this accident trend is occurring despite simultaneous improvements in sophistication and market penetration of Active Driver Assistant Systems (ADAS) technology. ADAS systems are safety systems designed to better protect road-users from accidents due to driver error. The inventor has identified that there is a need for ADAS vehicle systems to better protect road users from potential accidents caused by drivers using mobile devices.

There are many ways that mobile devices are used in vehicles by drivers. The device can be held in the hand, sitting in the vehicle console (often near the gear lever), resting on the knee, or mounted on the dashboard. If the driver is speaking to another person on a call, they may be holding the device to their ear, or near their mouth, or using the Bluetooth “hands-free” function to talk via the car's built-in speaker/microphone system. Alternatively, they may be attempting to play music through the car speaker system, using a software app to help navigate, using the camera on the device to record images or video of themselves, or using one of many thousands of apps including social networking and watching video content. While talking on the phone to another person shows a variable risk-profile, accident studies clearly reveal that texting with a mobile device presents a severe accident risk. (https://www.iihs.org/topics/distracted-driving).

The inventor has identified that the problem of detecting if a driver is being distracted by a mobile device is non-trivial. Firstly, there may be passengers in the vehicle, each wishing to use their device, so solutions that attempt to detect mobile devices and disable them, must resolve how to distinguish driver use from passenger use. One method is to attempt to determine the location of each mobile device in the vehicle cabin and if a device is “within the potential grasp” of the driver, to alter the device's modality in order to discourage it from being used by the driver. For example, mobile devices are usually connected to a radio network and will radiate electromagnetic energy from a radio modem, so antennas can be placed in the vehicle cabin to locate the device. Other similar localization approaches include (but are not limited to) the use of ultra-sonic sound waves, either produced by the mobile device and received by the vehicle, or vice-versa.

Computer-vision approaches may also be used to detect a mobile device from its appearance in visible wavelengths of light. However regardless of the underlying sensing method for localization, if a mobile device is within the cabin region where a driver may potentially reach out and touch it, this region almost always overlaps with the region of space that the front-seat passenger can also use their device. This leads to solutions which must trade off uncertainty of true vs false detection from such scenarios, and which consequently may either fail to detect the safety hazard, or falsely warn and irritate the driver, who may then learn to ignore any counter-measures.

At the heart of resolving this issue is not whether a driver is touching a mobile device, which in itself, is not a distraction risk per se. Rather it is the act of paying attention to the mobile device instead of the driving task, which presents a safety hazard. Therefore, paying attention to a mobile device is most accurately determined through observation of the driver's eyes making glances to the device whilst also undertaking the task of driving the vehicle.

Driving a vehicle demands the driver to be observing the road-scene for the majority of their time in order to maintain suitable situational awareness to perform vehicle control. In addition, glances to the vehicle instruments to monitor speed and general vehicle status, and also to rear and side mirrors in order for the driver to see around the vehicle are necessary. In contrast, glances made to locations which are not related to the driving task are unrelated to the vehicle control task and represent potential cases of mental distraction. While short glances to non-driving such as the passenger, or to the car radio, are not considered high risk, a combination of glance frequency and glance duration (of non-driving task glances) can be used to effectively model and detect driver distraction in real-time.

However, even when driver distraction is monitored, mobile devices represent a challenge due to the fact they can freely move about within the cabin. A mobile device may be permanently mounted or temporarily held in or near a region of the cabin where a driver also looks for performing the driving task, and in this circumstance a glance based driver distraction model will not be able to detect the hazard. Additionally, mobile devices are considered to be a particularly “attention grabbing”, due to the small display areas and high information content shown, combined with applications that have rich user interfaces that make use of touch-screen input by the user. So overall, vehicles and/or mobile devices need better methods to detect driver distraction by the mobile device.

PCT Patent Application Publication WO2018084273 entitled “Portable electronic device equipped with accident prevention countermeasure function” teaches discriminating a driver from a non-driver and taking counter-measures when gaze towards the screen is detected to be too high when the vehicle is travelling at speed. The driver discrimination routine includes

assessing gaze time on-screen relative to a forward direction (see paragraph [0018]). However, this necessarily requires accurate knowledge of where the mobile device the forward road scene is located relative to an imaging camera.

Any discussion of the background art throughout the specification should in no way be considered as an admission that such art is widely known or forms part of common general knowledge in the field.

### SUMMARY OF THE INVENTION

In accordance with a first aspect of the present invention, there is provided a method of detecting mobile device use of a driver of a vehicle, the method comprising:
receiving a sequence of images of at least the driver's head captured from a camera;
processing the sequence of images to determine visual attention of the driver based on detected head and/or eye movements of the driver over a period of time;
detecting mobile device use events within the period of time in which a user interacts with a mobile device that is located within the vehicle;
determining a temporal correlation of the visual attention of the driver with the mobile device use events over the period of time; and
determining that the driver is using the mobile device if the determined temporal correlation is greater than a threshold correlation coefficient.

In some embodiments, the mobile device use events include detected movement of the mobile device by an in-built inertial measurement unit. In some embodiments, the mobile device use events include touches at a user interface of the mobile device. In some embodiments, the mobile device use events include making or receiving a call on the mobile device. In some embodiments, detecting mobile device use events includes detecting the mobile device in one or more of the images in a location proximal to the driver.

In some embodiments, the camera is a vehicle-mounted camera. In other embodiments, the mobile device includes a mobile device camera and the mobile device use events include head and/or eye movement towards the mobile device measured from images captured by the mobile device camera.

In some embodiments, the vehicle includes one or more cabin cameras mounted within the vehicle cabin and positioned to monitor a region of the vehicle cabin. In these embodiments, the mobile device use events may be detected from computer vision analysis of a sequence of images obtained from the one or more cabin cameras.

In some embodiments, the visual attention includes one or more of eye gaze direction, head pose, eyelid movement or pupil movement.

In accordance with a second aspect of the present invention, there is provided a method of monitoring a driver of a vehicle, the method comprising:
receiving a sequence of images of at least the driver's head captured from a camera;
processing the sequence of images to determine visual attention of the driver based on detected head and/or eye movements of the driver over a period of time;
classifying the head and/or eye movements into one or more regions of interest and determining a mobile device region corresponding to a mobile device located within the vehicle;
calculating an amount of gaze time that the gaze direction falls within the mobile device region; and
determining that the driver is using the mobile device if the amount of gaze time within the mobile device region exceeds a predetermined threshold of time.

In some embodiments, the method of the second aspect includes the step of receiving vehicle velocity data indicating a current velocity of the vehicle and wherein determining that the driver is using the mobile device includes determining that the vehicle is moving.

In some embodiments, classification of the gaze direction into regions of interest includes determining target fixations where the driver's gaze remains within a predefined range of angles over a period of time greater than a predefined time threshold. The predefined range of angles may be within 5 degrees in either pitch or yaw.

In some embodiments, a region of interest is classified at least in part by a cluster of target fixations within the predetermined range of angles. In some embodiments, a cluster of target fixations includes at least 5 target fixations.

In some embodiments, the method of the second aspect includes the step of calculating the total gaze time within a region of interest over a predefined time window.

In some embodiments, the method of the second aspect includes the step of determining one of the regions of interest as a forward road region where the driver must look to safely drive the vehicle.

In some embodiments, the camera is part of a driver monitoring system fixed to the vehicle and positioned to monitor the driver. In these embodiments, the camera is preferably located at a known position and orientation within the vehicle and the forward road region is determined relative to this known position and orientation.

In some embodiments, the mobile device region is determined as one or more regions where mobile devices are used by vehicle drivers. In one embodiment, the mobile device region includes a region on or near the driver's lap.

In some embodiments, the method of the second aspect includes the step of determining a mobile device region includes detecting user activity at an input of the mobile device and temporally correlating eye gaze fixations with periods of user activity on the mobile device. In some embodiments, the step of determining a mobile device region includes detecting a mobile device in the received images at a position close to the driver.

In some embodiments, the camera is part of the mobile device that is within the vehicle. In these embodiments, the mobile device region may be determined based on the known geometry of the device screen relative to the camera position.

In some embodiments, the method of the second aspect includes the step of ranking the clusters according to total gaze time over the predefined time window. In some embodiments, when the vehicle is moving, a highest ranked gaze cluster having the greatest total gaze time is designated as the forward road scene. In some embodiments, when the vehicle is moving, the second highest ranked gaze cluster is designated as the mobile device region.

In some embodiments, the method of the second aspect includes the step of calculating the ratio of total gaze time within the forward road region to mobile device region.

In some embodiments, the method of the second aspect includes the step of characterizing that the imaged driver is the actual driver of the vehicle based on eye gaze behaviour towards the forward road region.

In some embodiments, the mobile device is detected to be within the vehicle based on connectivity between the mobile device and a vehicle computer. In some embodiments, the mobile device is detected to be within the vehicle based on a received GPS signal from the mobile device. In some embodiments, the mobile device is detected to be within the vehicle based on a received motion signal from an inertial measurement unit within the mobile device. In some embodiments, the mobile device is detected to be within the vehicle based on detection of the mobile device in one or more of the images.

In some embodiments, the predetermined threshold of time is determined based on a current speed that the vehicle is travelling.

In some embodiments, the method of the second aspect includes the step of imaging a subject from a mobile device camera that is part of the mobile device to determine a subject gaze direction over a period of time.

In some embodiments, the method of the second aspect includes the step of correlating glance behaviour from the driver gaze direction received from the driver monitoring system and from the subject gaze direction received from the mobile device camera.

In some embodiments, the method of the second aspect includes the step of determining if the subject imaged by the mobile device camera is the driver of the vehicle.

In some embodiments, the subject is characterized as the driver based on the correlation of glance behaviour.

In some embodiments, the mobile device region is determined, at least in part, by the correlation between the glance behaviour from the driver gaze direction received from both the mobile device camera and driver monitoring system.

In accordance with a third aspect of the present invention, there is provided a method of characterizing a subject as a vehicle driver, the method including the steps of:
capturing images of a subject in a vehicle from a camera of a mobile device;
processing the captured images to determine gaze direction of the imaged subject;
determining, based on the behaviour of the gaze direction over time, whether the subject is the driver of the vehicle or a passenger.

In some embodiments, the method includes the step of detecting that the vehicle is in motion. In some embodiments, the step of determining whether the subject is the driver includes characterizing the gaze direction into regions of interest including a forward road region corresponding to the road in front of the vehicle and a mobile device region corresponding to a location of the mobile device.

In some embodiments, the method of the third aspect includes the step of measuring an amount of time that the subject is gazing at the forward road region over a predetermined time window.

In accordance with a fourth aspect of the present invention, there is provided a system for detecting mobile device use of a driver of a vehicle, the system comprising:
a camera for capturing a sequence of images of at least the driver's head; and
a processor configured to:
   process the sequence of images to determine visual attention of the driver based on detected head and/or eye movements of the driver over a period of time;
   detect mobile device use events within the period of time in which a user interacts with a mobile device that is located within the vehicle;
   determine a temporal correlation of the visual attention of the driver with the mobile device use events over the period of time; and
   determine that the driver is using the mobile device if the determined temporal correlation is greater than a threshold correlation coefficient.

In accordance with a fifth aspect of the present invention, there is provided a system for monitoring a driver of a vehicle, the system comprising:
a camera for capturing a sequence of images of at least the driver's head; and
a processor configured to:
   process the sequence of images to determine visual attention of the driver based on detected head and/or eye movements of the driver over a period of time;
   classify the head and/or eye movements into one or more regions of interest and determining a mobile device region corresponding to a mobile device located within the vehicle;
   calculate an amount of gaze time that the gaze direction falls within the mobile device region; and
   determine that the driver is using the mobile device if the amount of gaze time within the mobile device region exceeds a predetermined threshold of time.

In accordance with a sixth aspect of the present invention, there is provided a system for characterizing a subject as a vehicle driver, the system comprising:
a camera for capturing images of a subject in a vehicle; and
a processor configured to:
   detect that the vehicle is in motion;
   process the captured images to determine gaze direction of the imaged subject;
   determine, based on the behaviour of the gaze direction over time, whether the subject is the driver of the vehicle or a passenger.

### BRIEF DESCRIPTION OF THE FIGURES

Example embodiments of the disclosure will now be described, by way of example only, with reference to the accompanying drawings in which:

FIG. 1 is a perspective view of the interior of a vehicle having a driver monitoring system including a camera and two light sources installed therein;

FIG. 2 is a driver's perspective view of a vehicle dashboard having the driver monitoring system of FIG. 1 installed therein;

FIG. 3 is a schematic functional view of a driver monitoring system according to FIGS. 1 and 2;

FIG. 4 is a system level diagram of a mobile device illustrating the primary functional components thereof;

FIG. 5 is a process flow diagram illustrating the primary steps in a method of detecting mobile device use of a vehicle driver using a vehicle-mounted camera;

FIG. 6 is a driver's perspective view of a vehicle scene showing example regions of interest and gaze fixation rays intersecting with the scene;

FIG. 7 is a process flow diagram illustrating sub-steps in a method of determining a mobile device region;

FIG. 8 illustrates 8 regions of interest determined by gaze fixation clusters ranked from highest to lowest in terms of total gaze time;

FIG. 9 is a process flow diagram illustrating the primary steps in a method of detecting mobile device use of a subject using a mobile device camera;

FIG. 10 is a process flow diagram illustrating the primary steps in a method of detecting mobile device use based on temporal correlation of visual attention of a subject and mobile device use events; and

FIG. 11 is a process flow diagram illustrating the primary steps in a method of determining that an imaged subject is a driver of a vehicle.

### DESCRIPTION OF THE INVENTION

Embodiments of the present invention are adapted to detect use of a mobile device by a vehicle operator by imaging the vehicle operator using a vehicle integrated driver monitoring system, the mobile device itself or a combination of both driver monitoring system and mobile device. Embodiments described herein relate specifically to imaging a driver of a car. However, it will be appreciated that the invention is also applicable to other vehicles and associated operators such as trucks, trains, airplanes and flight simulators.

### System Overview

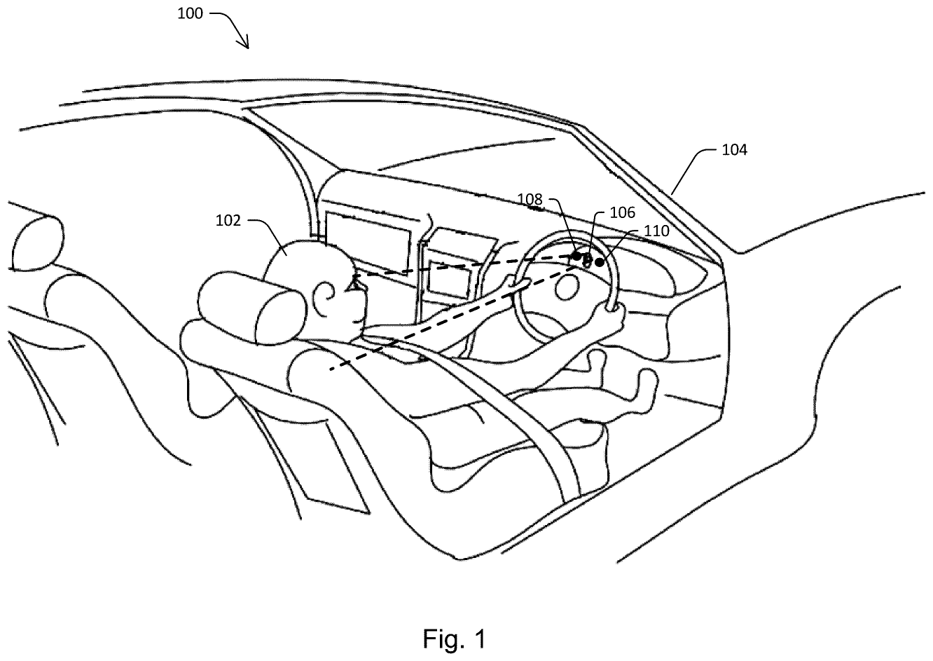

Referring initially to FIGS. 1 to 3, the main components of a driver monitoring system 100 will be described. System 100 is configured for capturing images of a vehicle driver 102 during operation of a vehicle 104. System 100 is further adapted for performing various image processing algorithms on the captured images such as facial detection, facial feature detection, facial recognition, facial feature recognition, facial tracking or facial feature tracking, such as tracking a person's eyes. Example image processing routines are described in U.S. Pat. No. 7,043,056 to Edwards et al. entitled “Facial Image Processing System” and assigned to Seeing Machines Pty Ltd (hereinafter “Edwards et al.”), the contents of which are incorporated herein by way of cross-reference.

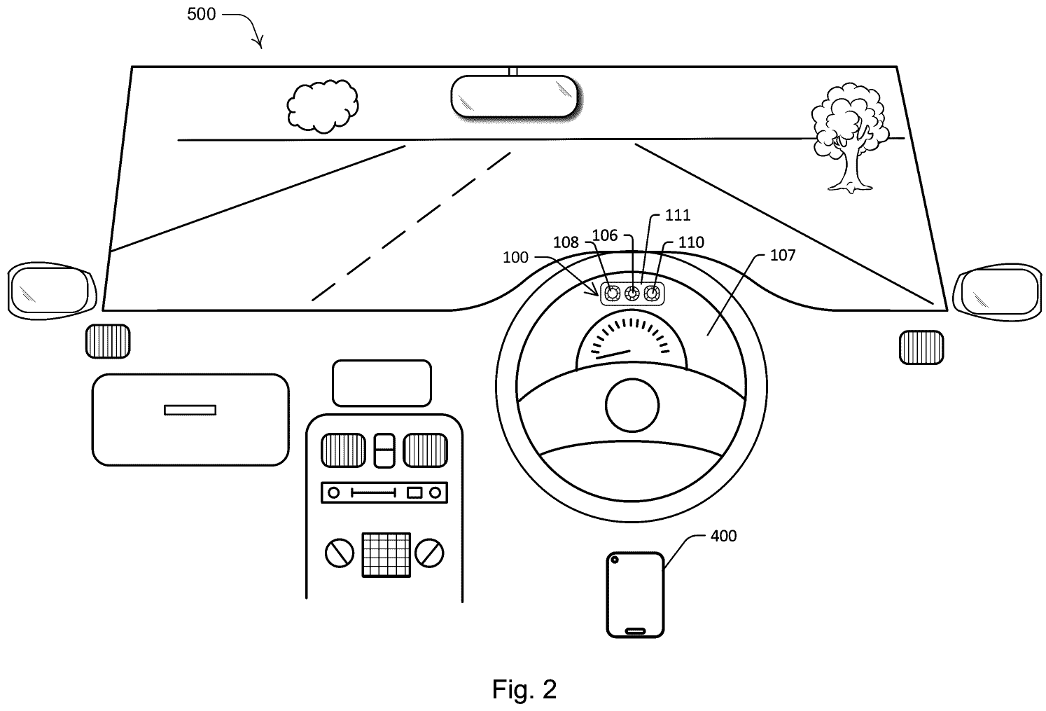

As best illustrated in FIG. 2, system 100 includes an imaging camera 106 that is positioned on or in the vehicle dash 107 instrument display and oriented to capture images of at least the driver's face in the infrared wavelength range to identify, locate and track one or more human facial features. Camera 106 may also be positioned to image part or all of the cabin of vehicle 104 in addition to the driver's face. In some embodiments, camera 106 may include a wide angled lens or fisheye lens to image the scene in wide angle.

Camera 106 may be a conventional CCD or CMOS based digital camera having a two dimensional array of photosensitive pixels and optionally the capability to determine range or depth (such as through one or more phase detect elements). The photosensitive pixels are capable of sensing electromagnetic radiation in the infrared range and optionally also in the visible range. In some embodiments, camera 106 incorporates an RGB-IR image sensor having pixels capable of simultaneously imaging in the infrared and visible wavelength range. Camera 106 may also be a three dimensional camera such as a time-of-flight camera or other scanning or range-based camera capable of imaging a scene in three dimensions. In other embodiments, camera 106 may be replaced by a pair of like cameras operating in a stereo configuration and calibrated to extract depth. Although camera 106 is preferably configured to image in the infrared wavelength range, it will be appreciated that, in alternative embodiments, camera 106 may image only in the visible wavelength range.

Referring still to FIG. 2, system 100, in a first embodiment, also includes a pair of infrared light sources 108 and 110 such as a Vertical Cavity Surface Emitting Lasers (VCSELs), Light Emitting Diodes (LEDs) or other light source. In further embodiments, each of light source 108 and 110 may comprise multiple VCSELs, LEDs or other light sources may be employed to illuminate driver 102. In some embodiments, only a single light source is used to illuminate driver 102. Light sources 108 and 110 are preferably located proximate to the camera on vehicle dash 107 such as within a distance of 5 mm to 50 mm.

Light sources 108 and 110 are adapted to illuminate driver 102 with infrared radiation, during predefined image capture periods when camera 106 is capturing an image, so as to enhance the driver's face to obtain high quality images of the driver's face or facial features. Operation of camera 106 and light sources 108 and 110 in the infrared range reduces visual distraction to the driver. Operation of camera 106 and light sources 108 and 110 is controlled by an associated controller 112 which comprises a computer processor or microprocessor and memory for storing and buffering the captured images from camera 106.

As best illustrated in FIG. 2, camera 106 and light sources 108 and 110 may be manufactured or built as a single unit 111 having a common housing. The unit 111 is shown installed in a vehicle dash 107 and may be fitted during manufacture of the vehicle or installed subsequently as an after-market product. In other embodiments, the driver monitoring system 100 may include one or more cameras and light sources mounted in any location suitable to capture images of the head or facial features of a driver, subject and/or passenger in a vehicle. By way of example, cameras and light sources may be located on a steering column, rearview mirror, center console or driver's side A-pillar of the vehicle. In the illustrated embodiment, the light source includes a single VCSEL or LED. In other embodiments, the light source (or each light source in the case of multiple light sources) may each include a plurality of individual VCSELs and/or LEDs.

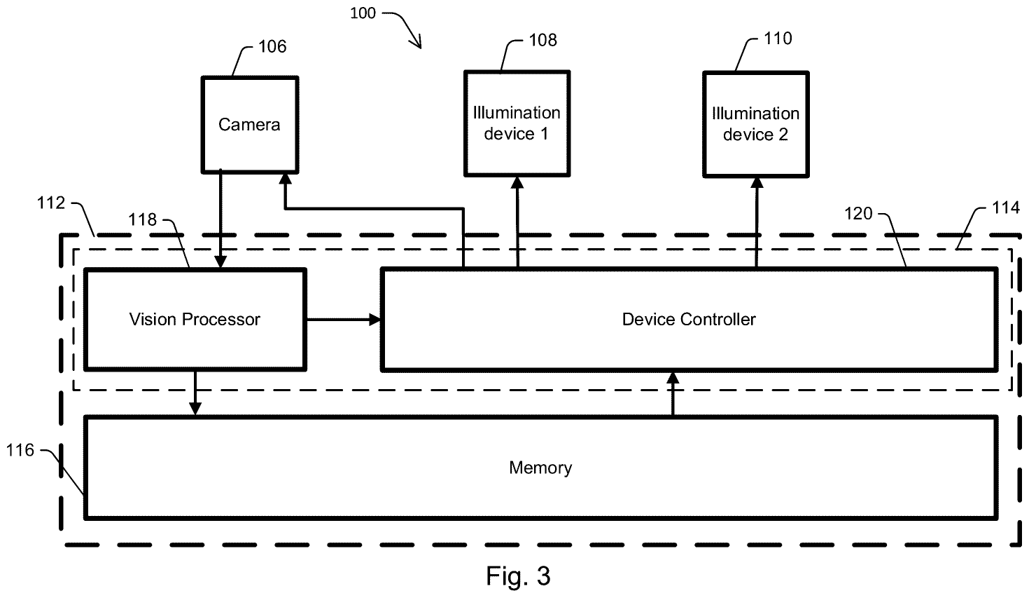

Turning now to FIG. 3, the functional components of system 100 are illustrated schematically. A system controller 112 acts as the central processor for system 100 and is configured to perform a number of functions as described below. Controller 112 is located within the dash 107 of vehicle 104 and may be connected to or integral with the vehicle on-board computer. In another embodiment, controller 112 may be located within a housing or module together with camera 106 and light sources 108 and 110. The housing or module is able to be sold as an after-market product, mounted to a vehicle dash and subsequently calibrated for use in that vehicle. In further embodiments, such as flight simulators, controller 112 may be an external computer or unit such as a personal computer.

Controller 112 may be implemented as any form of computer processing device or portion of a device that processes electronic data, e.g., from registers and/or memory to transform that electronic data into other electronic data that, e.g., may be stored in registers and/or memory. As illustrated in FIG. 3, controller 112 includes a microprocessor 114, executing code stored in memory 116, such as random access memory (RAM), read-only memory (ROM), electrically erasable programmable read-only memory (EEPROM), and other equivalent memory or storage systems as should be readily apparent to those skilled in the art.

Microprocessor 114 of controller 112 includes a vision processor 118 and a device controller 120. Vision processor 118 and device controller 120 represent functional elements which are both performed by microprocessor 114. However, it will be appreciated that, in alternative embodiments, vision processor 118 and device controller 120 may be realized as separate hardware such as microprocessors in conjunction with custom or specialized circuitry.

Vision processor 118 is configured to process the captured images to perform the driver monitoring; for example to determine a three dimensional head pose and/or eye gaze position of the driver 102 within the monitoring environment. To achieve this, vision processor 118 utilizes one or more eye gaze determination algorithms. This may include, by way of example, the methodology described in Edwards et al. Vision processor 118 may also perform various other functions including determining attributes of the driver 102 such as eye closure, blink rate and tracking the driver's head motion to detect driver attention, sleepiness or other issues that may interfere with the driver safely operating the vehicle.

The raw image data, gaze position data and other data obtained by vision processor 118 is stored in memory 116.

Device controller 120 is configured to control camera 106 and to selectively actuate light sources 108 and 110 in a sequenced manner in sync with the exposure time of camera 106. In some embodiments, the light sources 108 and 110 may be controlled to activate alternately during even and odd image frames to perform a strobing sequence. Other illumination sequences may be performed by device controller 120, such as L,L,R,R,L,L,R,R . . . or L,R,O,L,R,O,L,R,O . . . where “L” represents a left mounted light source, “R” represents a right mounted light source and “0” represents an image frame captured while both light sources are deactivated. Light sources 108 and 110 are preferably electrically connected to device controller 120 but may also be controlled wirelessly by controller 120 through wireless communication such as Bluetooth™ or WiFi™ communication.

Thus, during operation of vehicle 104, device controller 120 activates camera 106 to capture images of the face of driver 102 in a video sequence. Light sources 108 and 110 are activated and deactivated in synchronization with consecutive image frames captured by camera 106 to illuminate the driver during image capture. Working in conjunction, device controller 120 and vision processor 118 provide for capturing and processing images of the driver to obtain driver state information such as drowsiness, attention and gaze position during an ordinary operation of vehicle 104.

Additional components of the system may also be included within the common housing of unit 111 or may be provided as separate components according to other additional embodiments. In one embodiment, the operation of controller 112 is performed by an onboard vehicle computer system which is connected to camera 106 and light sources 108 and 110.

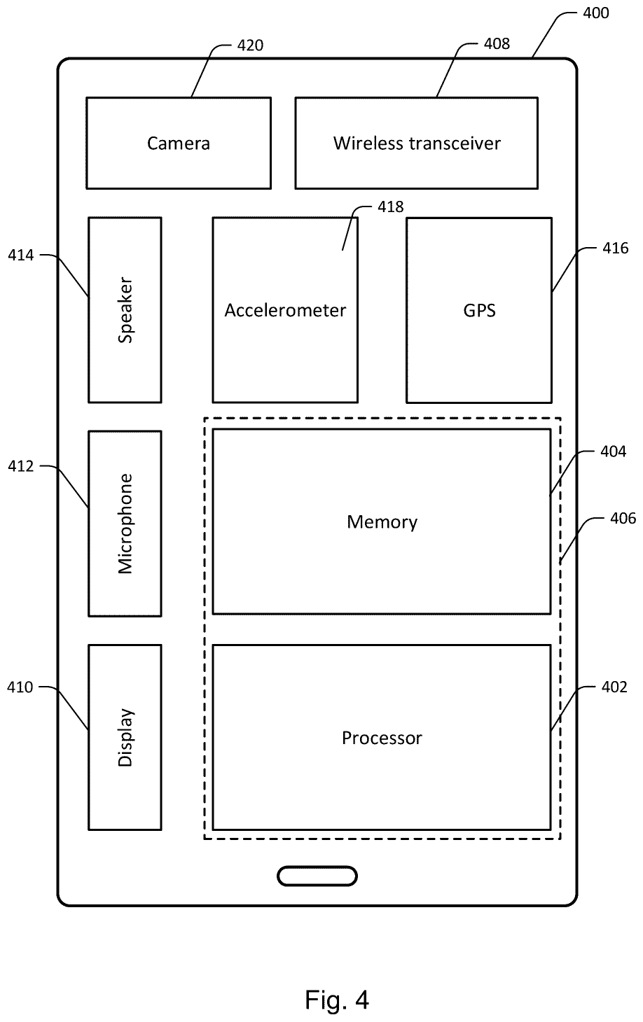

Referring now to FIG. 4, there is illustrated a system level overview of a conventional mobile device 400 such as a smartphone illustrating the primary functional components. Mobile device is illustrated as being a smartphone but it may represent other mobile devices such as tablet computers, laptop computers or other portable electronic devices.

Mobile device 400 includes a processor 402 for processing data stored in a memory 404. Processor 402 and memory 404 form a central processing unit (CPU) 406 of mobile device 400. Mobile device 400 also includes a wireless transceiver module 408 for sending and receiving signals wirelessly to allow mobile device 400 to communicate with other devices and systems. Wireless transceiver module 408 may include various conventional devices for communicating wirelessly over a number of different transmission protocols such as a Wi-FI™ chip, Bluetooth™ chip, 3G, 4G or 5G antenna, NFC chip and cellular network antenna. Mobile device 400 further includes a display 410 such as a touchscreen display for displaying information to a user, a microphone 412 for receiving audio input, a speaker 414 for outputting audio information to a user, a GPS device 416 for receiving a GPS location signal and an accelerometer 418 or other inertial measurement unit (IMU) for detection motion of mobile device 400. Finally, mobile device 400 includes one or more cameras 420 for capturing digital images from mobile device 400. Processor 402 includes hardware and/or software configured to process the images captured from cameras 420. Mobile device 400 may also include one or more illumination devices such as LEDs or VCSELs for illuminating a scene during image capture by cameras 420.

In some embodiments, mobile device 400 is capable of performing subject monitoring to determine a head pose, eye gaze direction, eye closure or other characteristic of a subject being imaged by cameras 420.

Mobile device 400 may be capable of being integrated with vehicle 104 via an on-board vehicle computer system or controller 112 of driver monitoring system 100.

In some embodiments, mobile device 400 may be capable of being mounted in a dock or device mount within vehicle 104 in a manner similar to that described in US Patent Application Publication 2018/026669 A1 entitled “Phone Docking Station for Enhanced Driving Safety” to Edwards and Kroeger and assigned to Seeing Machines Ltd. The contents of US 2018/026669 A1 are incorporated herein by way of cross reference.

### Detecting Mobile Device use Via a Vehicle Mounted Camera

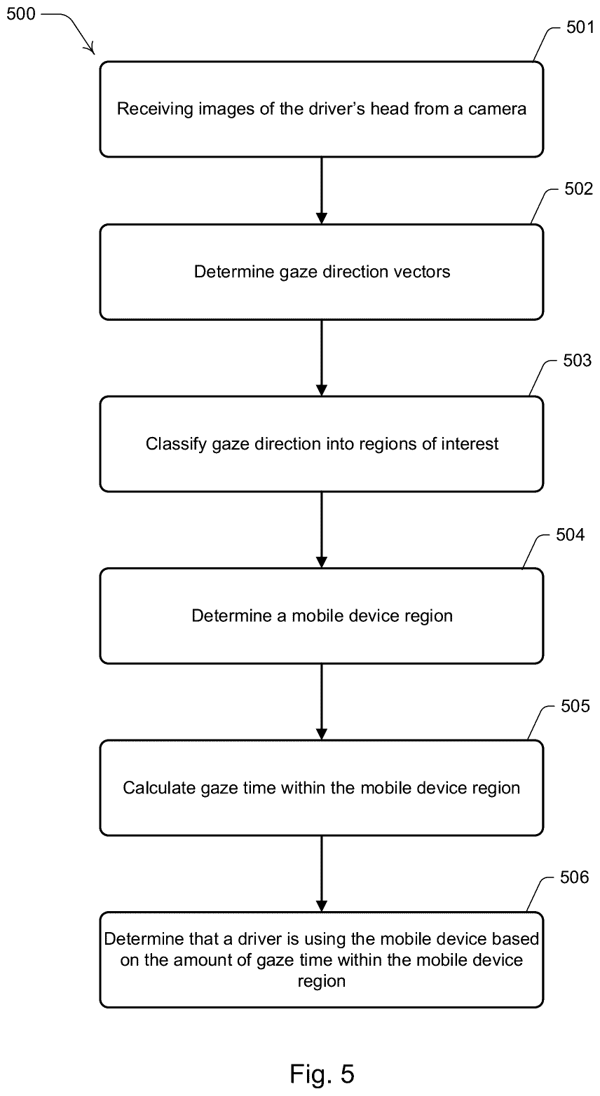

Referring now to FIG. 5, system 100 described above can be used to perform a method 500 of monitoring driver 102 of vehicle 104 to determine use of mobile device 400. The steps of method 500 will be described with reference to the components of system 100 of FIGS. 1 to 3.

Prior to performing method 500, system 100 may first detect that mobile device 400 is present within vehicle 104 based on connectivity between mobile device 400 and a vehicle computer or system 100 or other techniques. By way of example, mobile device 400 may be paired with system 100 or vehicle 104 via Bluetooth or communicate via RFID and this pairing or communication is used to confirm that mobile device 400 is within vehicle 104 when vehicle 104 is moving. Alternatively or in addition, mobile device 400 may be detected to be within vehicle 104 based on a received GPS signal from mobile device 400 to indicate a position of mobile device 400 co-located with vehicle 104 when vehicle 104 is in motion. This GPS signal may be communicated from mobile device 400 to system 100 to compare with a vehicle GPS location or otherwise confirm the presence of mobile device 400 in vehicle 104. Alternatively or in addition, mobile device 400 may be detected to be within vehicle 104 based on a received velocity or other motion signal from accelerometer 418 within mobile device 104. By way of example, if accelerometer 418 detects a velocity or acceleration that substantially matches that of vehicle 104 (within a margin of error), then system 100 is alerted that mobile device 400 is present within vehicle 104. Furthermore, mobile device 400 may be detected to be within vehicle 104 by direct detection of mobile device 400 in one or more images captured by camera 106 and processed b processor 118. By way of example, camera 106 may detect mobile device 400 while being held by driver 102. Vision processor 118 is able to detect mobile device 400 by way of known object detection techniques, which may include comparing the images with one or more reference images of mobile devices.

Method 500 comprises the initial step 501 of receiving a sequence of images of the head of driver 102 captured from camera 106. At step 502, vision processor 118 processes the sequence of images to determine the driver's visual attention over a period of time. The visual attention includes detecting head and/or eye movements and may include one or both of eye gaze direction vector and/or a head pose vector determined by facial feature identification. By way of example, the gaze direction or head pose estimation may be performed by the methods described in Edwards et al. or those described in PCT Patent Application Publication WO 2020/061650 A1 entitled “Driver Attention State estimation” to Edwards and Noble and assigned to Seeing Machines Limited. The contents of WO 2020/061650 A1 are incorporated herein by way of cross reference. However, it will be appreciated that various other methods of determining subject gaze may be implemented such as determining eye gaze vectors via specular reflections from the corneas. The gaze direction may be represented as a gaze vector having a direction that extends from a point on the driver's face to a position within or outside the vehicle 104. For the purpose of this description, visual attention direction vectors derived from either eye gaze or head pose will be referred to as gaze direction vectors.

The period of time over which the driver is imaged may range from a few seconds to a few minutes and is preferably performed on a repeated basis when the vehicle is in motion.

In some embodiments, the gaze direction vectors may be represented as a unified gaze ray. This unified gaze ray represents the direction of current attention of driver 102 and may be represented as a three-dimensional element vector indicating an origin in three-dimensional space and a three-dimensional direction unit vector indicating a direction in the three-dimensional space. The unified gaze ray may be formed from subject attention data including but not limited to eye gaze data and/or head pose data depending on the availability of data during current image frames. By way of example, if eye gaze data of both of the driver's eyes can be obtained (both eyes visible and open), then the unified gaze ray may have an origin at the midpoint between the two eye centers. If one eye is not visible, then the unified gaze ray may have its origin at the one visible eye. If neither eye is visible, then the unified gaze ray may be determined by a head pose direction and centered on a region of the driver's head.

A gaze direction vector may be calculated for each image frame where the driver's face or eyes can be confidently determined. In some embodiments, gaze direction vectors may be calculated for only a subset of the images captured by camera 106. The determined gaze direction vectors may be stored in memory 116 for subsequent processing by vision processor 118. The stored gaze direction vectors may be represented as a time series of two or three dimensional vectors.

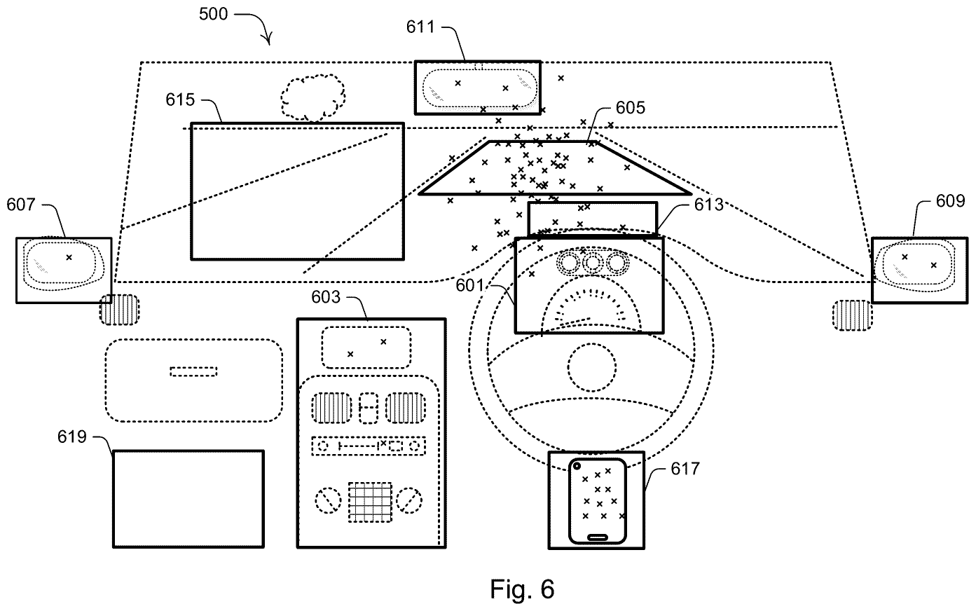

At step 503, the gaze direction is classified into one or more regions of interest (ROIs) within the scene to identify areas of common viewing by driver 102. The scene may include the interior of vehicle 102, a view of the forward road scene and other regions such as the side and rearview mirrors and vehicle side road scene. An example driving scene as viewed from a driver is illustrated in FIG. 2. Example regions of interest are illustrated in FIG. 6 and include a vehicle instrument cluster ROI 601, center console ROI 603, center of forward road ROI 605, left side mirror ROI 607, right side mirror ROI 609, rearview mirror ROI 611, HUD display ROI 613, passenger side on road ROI 615, driver lap ROI 617 and passenger footwell ROI619. Various other ROIs may be designated depending on the scene, vehicle model and objects contained therein.

The ROIs need not be predefined and may be characterized fully from the gaze behavior without knowledge of the physical objects or areas that the regions represent. In these embodiments, the regions of interest simply reflect clusters of gaze direction vectors within confined ranges of angles. However, in other embodiments, where prior knowledge of the scene and camera location is known, some or all of the regions of interest may be known and predefined as ranges of angles relative to camera 102.

Where the ROIs are determined by gaze behaviour, vision processor 118 determines target fixations where the driver's gaze direction vector remains within a predefined range of angles over a period of time greater than a predefined time threshold. The predetermined time threshold is preferably selected to be greater than the typical eye movement time during a saccade. By way of example, the predetermined time threshold may be 250 milliseconds, 500 milliseconds or 1 second. The predefined range of angles may be within 10°, 5°, 3°, 2° or 1° in either pitch or yaw depending on the distance between driver 102 and camera 106. One or more ROIs may then be classified at least in part by a cluster of target fixations within the predetermined range of angles. By way of example, a cluster of target fixations may include at least 5 target fixations.

FIG. 6 illustrates target fixations as crosses superimposed on the scene. Here, clusters of target fixations are found, inter alfa, in the road scene ROI 605, display ROI 613 and driver lap ROI 617. These clusters may be used to define a ROI even if context of what that ROI physically represents is not known.

The ROIs may be defined and represented within the scene as polygonal geometry or mesh regions with appropriate dimensions specified in the coordinates of a vehicle frame of reference. Further, the ROIs may be static or dynamic. Static ROIs include fixed objects or regions within or on vehicle 104 (using a fixed vehicle frame of reference), such as the rearview mirror and side mirrors. Dynamic ROIs include objects or regions that vary dynamically in size, position and/or shape over time with respect to the vehicle frame of reference. Example dynamic regions include the forward road scene and objects viewed by the driver through the front or side windows, or through the rearview mirror.

By way of example, the road scene ROI 605 may be defined by a unique, dynamic mesh item that represents the road ahead. The geometry of the mesh may be deformed during processing based on per-frame input from a forward-facing camera (e.g. dash-mounted camera) which parameterizes a current road situation. This is done in terms of properties like curvature, gradient, lane count, etc. The road mesh may include the horizontal road surface itself, and also vertical planes capturing the central horizon above the road where driving-related activity occurs.

Camera 106 is fixed with respect to a vehicle frame of reference and is initially calibrated such that its location and orientation are known within the scene. Furthermore, the scene being imaged may be digitally represented such that the three-dimensional geometry of objects and regions within the scene are known. This allows the ROIs to be defined as regions within the scene. The scene geometry may be determined, at least in part, from a three-dimensional model of the vehicle such as a CAD model provided by a vehicle manufacturer. The scene geometry may also be determined from one or more two or three-dimensional images of the scene captured by camera 106 and/or other cameras in or around the scene. In either embodiment, the digital representation of the scene may include positions and orientations of known features within the scene, which may be defined in a vehicle frame of reference. By way of example, the known features may include individual vehicle dashboard instruments, definable cabin contours, edges, or objects or the entire vehicle cabin itself. The features may be fixed in time and space relative to a frame of reference such as a vehicle frame of reference defined relative to a region of the vehicle frame.

Example methodology on registration of scene geometry is described in PCT Patent Application Publication WO 2018/000037 A1 to Noble et al., entitled “Systems and methods for identifying pose of cameras in a scene” and assigned to Seeing Machines Limited (hereinafter “Noble et al.”). The contents of Noble et al. are incorporated herein by way of cross reference. By way of example, a reference coordinate system may be defined as having a z-axis aligned along the vehicle drive shaft (longitudinal dimension), an x-axis aligned along the front wheel axle (defining a transverse dimension) with the right wheel being in the positive direction and a y-axis defining a generally vertical dimension to complete the orthogonal coordinate system.

Therefore, step 503 of classifying the gaze direction into regions of interest may simply include designating regions of gaze clusters or may include a full classification with known features in the vehicle scene. In general, only a forward road region and a mobile device region are required to determine if a driver is using the mobile device.

At step 504, one of the regions of interest is determined as a mobile device region corresponding to a mobile device located within the vehicle. This determination may be achieved by a number of methods based on determined gaze behavior. In one embodiment, the mobile device region is determined by correlating the position of a cluster of gaze target fixations with one or more regions where mobile devices are typically used by vehicle drivers. Typical regions include a driver's lap and regions near the center console. By way of example, a cluster of gaze target fixations detected on or near the driver's lap (e.g. ROI 617 in FIG. 6) may cause vision processor 118 to designate that region as a mobile device region.

In some embodiments, determining a mobile device region may include detecting mobile device use events at an input of the mobile device 400, such as input at a touchscreen display 410 or making/receiving a call and temporally correlating eye gaze target fixations with periods of user activity on the mobile device 400. Mobile device use events may also be detected based on detected movement of the mobile device 400 by accelerometer 418 or gaze towards mobile device 400 detected by camera 420 on the device itself. An alternate method of determining mobile device use based solely on correlation between visual attention and mobile device use events is described in detail below.

Mobile device use events may also include detecting mobile device 400 being held by driver 102 such as at the driver's ear during a call or in the driver's hand manipulating the device. Detection of mobile device 400 may involve object detection of the device in one or more of the images by processor 118. The detection may also include determining, by processor 118 the relative position of mobile device 400 to driver 102.

In embodiments involving detection of mobile device use, mobile device 400 may be configured to be in communication with system 100 either wirelessly (e.g. via Bluetooth) or through a wired connection (e.g. USB) or mobile device dock that integrates with vehicle 104. Detection of correlation between glances and user input on a mobile device 400 may be used by vision processor 118 to characterize a mobile device ROI if the correlated glance behaviour falls within a confined range of angles (corresponding to a mobile device). This confined range of angles may be defined by a pitch and yaw of ±5°, ±10°, ±15° or other range of angles suitable to represent a size of a display of the mobile device 400.

In some embodiments, the mobile device region is determined by statistical analysis of the gaze target fixation clusters. This may be performed where the regions of interest are not predefined within the scene and are determined based solely on clusters of gaze target fixations.

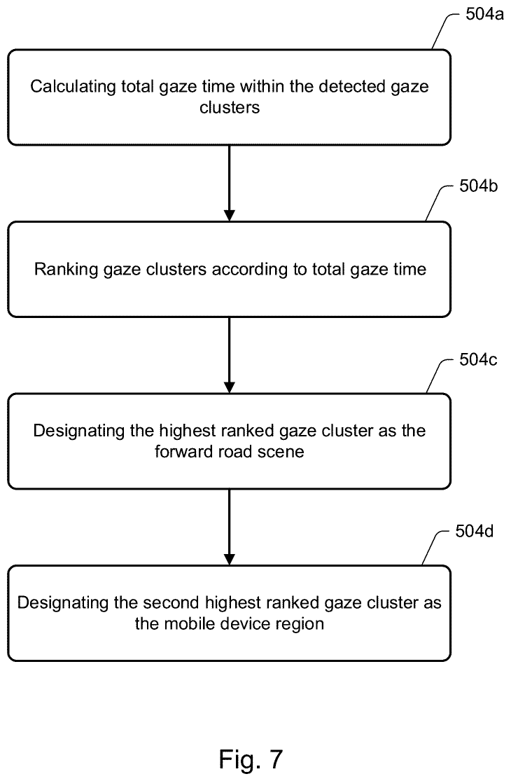

Referring now to FIG. 7, there is illustrated exemplary sub-steps of step 504 to determine a mobile device region based on statistical analysis of the gaze fixation clusters. In this embodiment, a region of interest is a cluster of gaze fixations. At sub-step 504a, vision processor 118 calculates the total gaze time within each region of interest or at least a subset of the regions of interest over a predefined time window. This time window might range from a few seconds to a few minutes and may be the same as the period in which the driver is monitored at step 501 or a subset thereof. The gaze time of a gaze fixation may be calculated by the number of image frames in a sequence of images spanning the gaze fixation multiplied by the camera frame rate. The camera exposure time may also be taken into account. The total gaze time of a region of interest is then the sum of the individual gaze times of each gaze fixation within the cluster of that region.

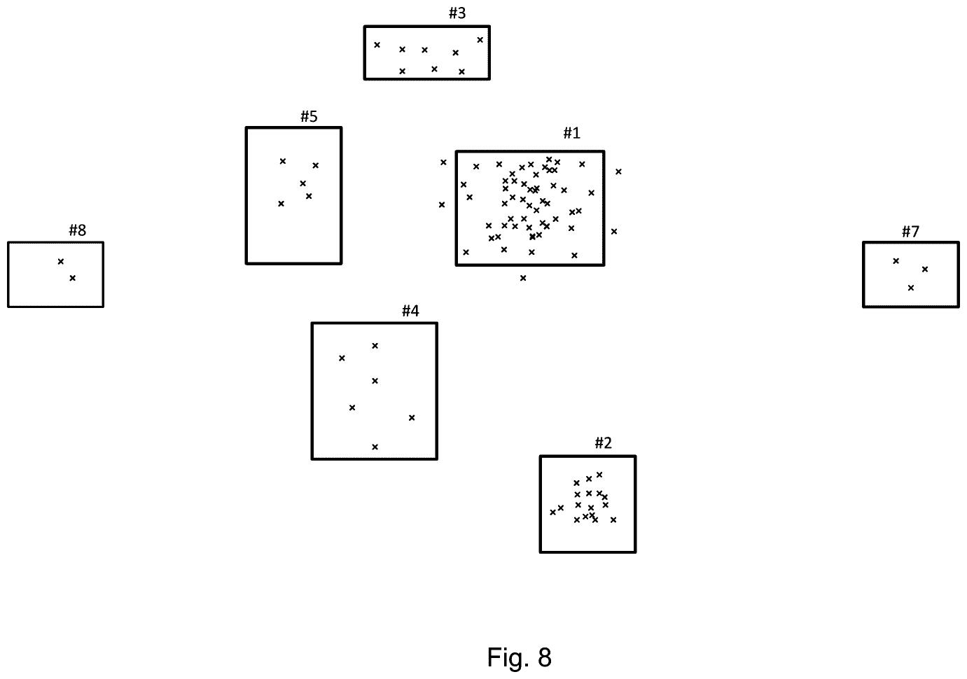

At sub-step 504b, vision processor 118 ranks the clusters or regions of interest according to total gaze time over the predefined time window. FIG. 8 illustrates 8 regions of interest determined by gaze fixation clusters ranked from highest to lowest in terms of total gaze time, wherein a higher total gaze time is ranked higher than a lower total gaze time. At sub-step 504c, when the vehicle is detected to be moving, a highest ranked gaze cluster having the greatest total gaze time is designated as the forward road scene. At sub-step 504d, when the vehicle is detected to be moving, the second highest ranked gaze cluster is designated as the mobile device region as a default. This determination of a mobile device region may be performed at regular intervals as the mobile device may change locations.

The sub-steps described above and illustrated in FIG. 7 may incorrectly designate another region as the mobile device region if the driver is spending a lot of time glancing at an instrument such as the infotainment screen or in the rear-view mirror. To counter this, the method of FIG. 7 may be augmented with detection of mobile device use events and correlation with the gaze fixations. The method may be further augmented with knowledge of the position of the gaze clusters relative to the known position of camera 102. This information might, for example, rule out a rear-view mirror region being incorrectly designated as the mobile device region as it is unlikely a mobile device is positioned at such a location. By incorporating this correlation, a lower ranked gaze cluster having a high correlation with detected mobile device use events may be designated as the mobile device region.

In other embodiments, the mobile device region is determined by direct detection of mobile device 400 in the captured images. This mobile device detection may be achieved by vision processor 118 performing object detection and/or shape recognition of mobile device 400. In this regard, vision processor 118 may include an object classifier that is adapted to detect likely mobile devices based on similarities to images of known mobile devices.

In some embodiments, the mobile device may be momentarily in view of camera 106 before being positioned near the driver's lap or another area in which the device is being used. Processor 118 is able to detect the presence of mobile device 400 and use this as validation to commence performing step 504 to determine a mobile device region. The validation that mobile device 400 may instruct processor 118 that subsequent frequent/prolonged glance downs are even more likely to be due to mobile device usage (and thus improve a confidence measure).

Returning to FIG. 5, at step 505, with the mobile device region designated, an amount of gaze time that the gaze direction falls within the mobile device region is calculated by vision processor 118. This calculation may have already been performed at step 504 if the statistical process of FIG. 7 was used to determine the mobile device region. If not, step 505 involves summing the individual gaze fixation times within the mobile device region to obtain a total gaze time. This might be achieved, for example, by determining the number of image frames in a sequence of images spanning the gaze fixation multiplied by the camera frame rate. The camera exposure time may also be taken into account.

Finally, at step 506, vision processor 118 determines that the driver 104 is using mobile device 400 if the amount of gaze time within the mobile device region exceeds a predetermined threshold of gaze time. By way of example, this threshold of gaze time may be in the range of 1 to 5 seconds per 10 second period or 5 to 10 seconds over a 30 second period.

Method 500 may also include the step of calculating the ratio of total gaze time within the forward road region to that of the mobile device region. In some embodiments, the predetermined threshold of gaze time is determined relative to a total gaze time within the forward road scene. By way of example, the predetermined threshold may be a ratio of 1:1, 1:1.5, 1:2, 1:3 or similar of gaze time towards the mobile device region compared to the forward road region.

In some embodiments, vehicle velocity data is received and input to vision processor 118 or controller 112. The current velocity of the vehicle may be taken into account when determining that the driver is using the mobile device. In some embodiments, the predetermined threshold of gaze time is determined based on a current speed that the vehicle is travelling. For example, the threshold of time for gaze time towards the mobile device region may be lower when the vehicle is travelling at higher speeds. Similarly, the threshold ratio of gaze time towards the mobile device region to the forward road scene will typically be smaller when the vehicle is travelling faster.

In some embodiments, upon detection of a level of mobile device use by the driver, system 100 is configured to issue an alert to the driver or a third party. In some embodiments, this alert may be issued when the driver is determined to be using the mobile device and the vehicle is moving at a speed greater than a predetermined threshold speed.

### Detecting Mobile Device use Via a Device Camera

Method 500 described above relies on imaging driver 104 from vehicle-mounted camera 106. As most modern mobile devices include their own in-built camera (e.g. camera 420 in FIG. 4), this camera can be used in place of camera 106 or in addition to camera 106 to detect mobile device use. Using this camera has the advantage of being able to easily detect when a user is viewing the device due to the close proximity between the camera 420 and its display 410. Using device camera 420 also has the advantage of directly validating that mobile device 400 is in operation within vehicle 104. However, as the position of mobile device 400 is generally not fixed to the vehicle, in using device camera 420, it is more difficult to determine a forward road scene and even determine whether the person being imaged is the vehicle driver or a passenger.

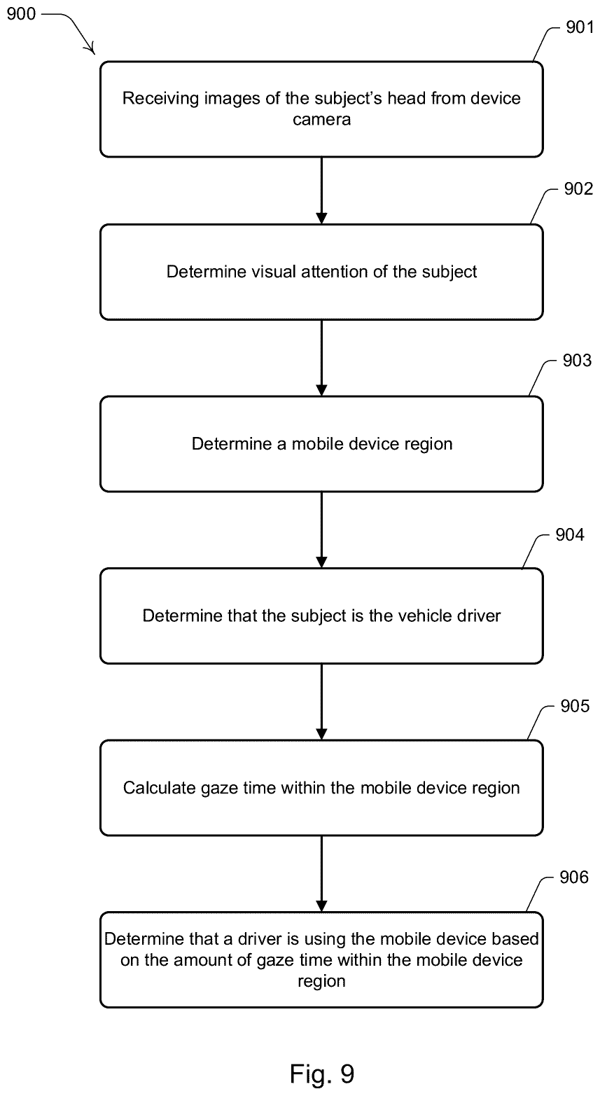

Referring now to FIG. 9, there is illustrated a method 900 of determining mobile device use by a vehicle driver using the camera of the device. Method 900 may be performed by device processor 402 or by an on-board vehicle computer processor if device 400 is connected or paired with the vehicle. By way of example, mobile device 400 may be paired with an on-board vehicle computer via the Apple CarPlay™ system developed by Apple Inc. or Android Auto™ system developed by Google Inc. For simplicity, method 900 will be described as being performed by device processor 402.

At step 901, device processor 402 receives images of a subject's head from device camera 420. At this point, it is unknown whether the subject being imaged is the vehicle driver or a passenger. At step 902, the images are processed by processor 402 to determine a visual attention of the subject over a period of time. Like with method 500, the visual attention includes detecting head and/or eye movements and may include one or both of eye gaze direction vector and/or a head pose vector determined by facial feature identification.

At step 903, a mobile device region is determined from the visual attention data. The mobile device region may be determined by detecting gaze fixation clusters within a range of angles from the axis of camera 420. Held at a distance of 60 cm, a mobile device screen having a 6 inch screen (−18 cm) may allow a user to view the device display at angles up to about 17 degrees (or 0.29 radians) from the camera. At a distance of about 1 m, the range of angles reduces to about 10 degrees (or 0.18 radians). The distance to the subject can be estimated by the relative size of the head compared to the average size of the human head. Thus, a mobile device region can be defined as a gaze region within about 10 to 20 degrees from device camera 420.

At step 904, the processor 402 analyses the visual attention data determined in step 903 to obtain gaze behavior and determine whether the subject being imaged is the vehicle driver or a passenger. A primary characteristic of a vehicle driver is that they will be gazing at the forward road scene for a large proportion of time when the vehicle is in motion. This forward road region can be identified as a cluster of gaze fixations within a small range of angles. If the subject is not the vehicle driver, then the subject is likely to view the forward road scene much less regularly than a driver. This characteristic behavior can be used to distinguish a vehicle driver from a non-driver and also determine a forward road region of interest.

At step, 905, device processor 402 calculates a total gaze time within the mobile device region over a predetermined period of time such as 10 seconds, 20 seconds 30 seconds etc by summing the individual gaze fixation times within the mobile device region. Finally, at step 906, device processor 402 determines that the driver is using the mobile device if the amount of total gaze time within the mobile device region is greater than a predetermined threshold of gaze time. By way of example, this threshold of gaze time may be in the range of 1 to 5 seconds per 10 second period or 5 to 10 seconds over a 30 second period.

### Correlation-Based Detection of Mobile Device Use

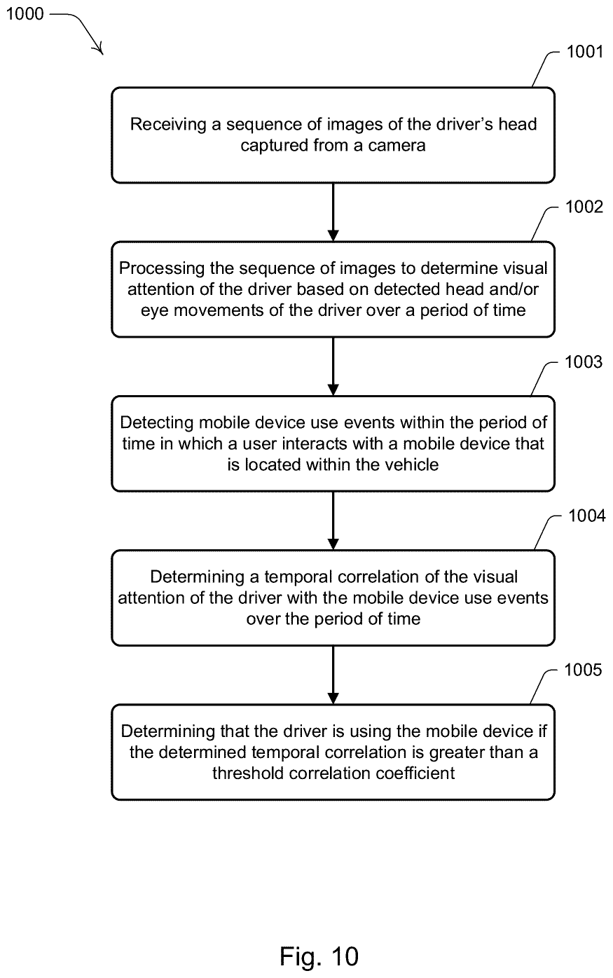

Referring now to FIG. 10, system 100 can be used to perform an alternate method 1000 of detecting mobile device use of driver 102 of vehicle 104. Method 1000 comprises, at step 1001, receiving a sequence of images of the driver's head captured from camera 106. At step 1002, vision processor 118 processes the sequence of images to determine visual attention of driver 102 based on detected head and/or eye movements of driver 102 over a period of time. The period of time may be a few seconds to a few minutes. The measured visual attention includes measuring one or more of eye gaze direction, head pose, eyelid movement, eye closure or pupil movement. For example, the detected visual attention may include detecting pupil movement and eye gaze direction or head pose to detect a driver reading text on display 410 of mobile device 400.

At step 1003, mobile device use events are detected within the period of time. Mobile device use events may include events in which a user is detected to interact with mobile device 400 that is located within vehicle 104. Mobile device 400 may be detected to be within vehicle 104 by the techniques described above, including Bluetooth pairing with a vehicle computer or system 100, GPS signal or velocity/acceleration signal matching that of vehicle 104.

The detected mobile device use events include detected physical movement of mobile device 400 by an in-built inertial measurement unit such as accelerometer 418. For example, if driver 102 is holding or picking up mobile device 400, this movement can be detected by accelerometer 418. The detected mobile device use events may include physical touches at a user interface of the mobile device such as touchscreen display 410 or other buttons on device 400 such as a fingerprint scanner, lock button or volume button. Mobile phone use events may also include detection of the making or receiving of a call on mobile device 400. By way of example, mobile device 400 may be detected in the images as being held by driver 102 such as at the driver's ear suggesting a call is in place.

The mobile device use events need not be physical interactions with mobile device 400. In some embodiments, mobile device use events include head and/or eye movement towards the mobile device 400 measured from images captured by mobile device camera 420, camera 106 or other cameras located within vehicle 104. In some embodiments, the vehicle 104 includes one or more cabin cameras (not shown) mounted within the vehicle cabin (such as occupant monitoring cameras) and positioned to monitor a region of the vehicle cabin. In these embodiments, the mobile device use events may be detected from computer vision analysis of a sequence of images obtained from the one or more cabin cameras. By way of example, the cabin cameras may image head and/or eye movement of the driver. If the cabin cameras are located at known positions within the vehicle, the driver's glances (e.g. head pose or eye gaze) can be mapped to a known coordinate frame and determined in three dimensions. In this manner, the cabin camera(s) can be used to detect when the driver is glancing towards the mobile device region or otherwise.

The one or more cabin cameras may also be adapted to detect physical movements of the driver that indicate mobile device use events. These physical movements may include the driver reaching for the mobile device or the driver holding the mobile device to their ear to conduct a phone call. The detected physical movements of driver 102 may be detected by a machine classifier such as a neural network classifier trained using a database of images of subject motions and mobile device use events.

The one or more cabin cameras may also be adapted to detect the presence, position and operation of mobile device 400 within vehicle 104. This may be achieved by way of object detection and/or shape recognition of the mobile device in the captured images.

At step 1004, a temporal correlation of the visual attention of the driver is made with the mobile device use events over the period of time. The visual attention may be stored as a time series or multiple time series of data such as eye gaze, head pose, eye closure etc. Similarly, detected device use may be stored as time series such as device input signal, accelerometer time series data, GPS time series data and head and eye movement signals obtained from images of mobile device camera 420. In some embodiments, the temporal correlation may be performed by calculating a cross correlation of one or more of the driver attention time series with one or more of the device use time series datasets. An example cross correlation formula for correlating two discrete time series x[k] and y[k] is as follows:

$${R}_{x y} [ k ] = {\sum }_{m = - ∞}^{∞} x [ m ] y [ m - k ]$$

Where k is any integer in the domain −∞≤k≤∞.

In some embodiments, the temporal correlation may be performed by calculating a correlation function over predefined time intervals of the time series data, such as every 1 second, 5 seconds or 10 seconds. A formula for calculating the correlation coefficient for comparing two discrete time series x[k] and y[k] is as follows:

$${C}_{x y} = \frac{{R}_{x y} [ 0 ]}{\sqrt{{R}_{x x} [ 0 ] {R}_{y y} [ 0 ]}}$$

Where Rₓₓ is the autocorrelation function for series x and R_{yy} is the autocorrelation function for series y. The correlation coefficient has values between −1 and 1 where values close to 1 indicate a high correlation (or similar signals), a value close to 0 indicates a low correlation and a value close to −1 indicates a high anticorrelation (opposite signals).

At step 1005, vision processor 118 determines that the driver is using the mobile device if the determined temporal correlation is greater than a threshold correlation coefficient. In the case of estimating a correlation coefficient at step 1004, this determination might include detecting when the correlation coefficient goes above 0.5, 0.6, 0.7, 0.8 or 0.9. In some instances, a high degree of anticorrelation might also indicate mobile phone use. In these instances, determination of the absolute value of the correlation coefficient might be useful.

Although method 1000 is described as being performed by system 100 using vehicle-mounted camera 106, it will be appreciated that a similar method may be performed using mobile device 400 itself and device camera 420 to image the subject. In these embodiments, the detected visual attention may be used to first characterize that the subject being imaged is driver 102.

### Characterizing a Driver of a Vehicle Based on Eye Gaze Behavior

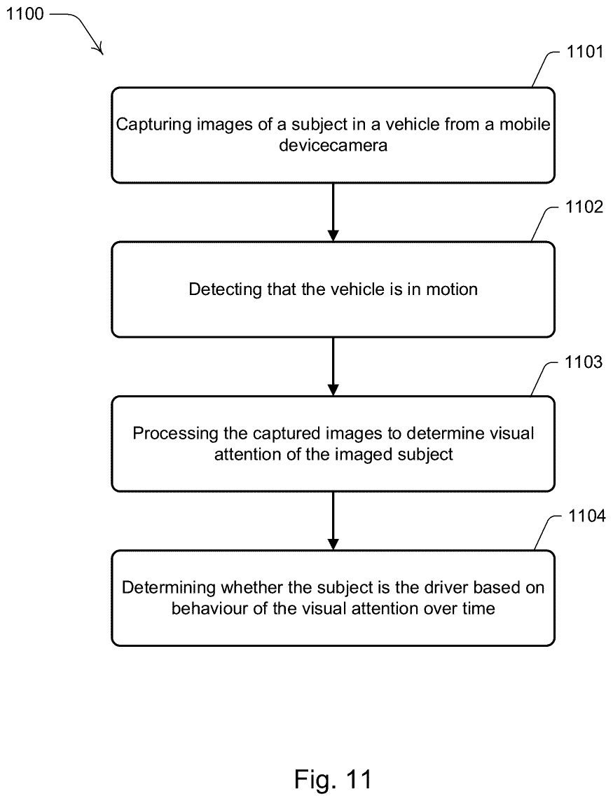

Using the above techniques, mobile device 400 can be used to characterise a subject as a vehicle driver or not. Such a method 1100 is illustrated in FIG. 11. Method 1100 includes, at step, 1101, capturing images of a subject in vehicle 104 from mobile device camera 420. At step 1102, vehicle 104 is detected to be in motion. This may be achieved by detecting a velocity signal or GPS signal from mobile device, or by pairing mobile device 400 to vehicle 104 and receiving vehicle velocity data. It will be appreciated that step 1102 may be performed in conjunction with step 1101. In some embodiments, step 1102 is optional.

At step 1103, mobile device processor 402 processes the captured images to determine visual attention of the imaged subject. As per above, the visual attention may include head and/or eye movements such as eye gaze direction, head pose, eyelid movement, eye closure or pupil movement.

At step 1104, mobile device processor 402 determines whether the subject is driver 102 of vehicle 104 or a passenger based on the behaviour of the visual attention over time. The behaviour may include the detection of regular glances towards a forward road region. These may be detected as gaze fixations within a predefined region of interest representing the forward road or simply a cluster of gaze fixations on a single region. In some embodiments, step 1104 includes measuring an amount of time that the subject is gazing at the forward road region over a predetermined time window.

In some embodiments, a classifier may be built based on known driver visual attention or glance behaviour. Then, at step 1104, the classifier may be applied to the visual attention data to classify the subject as a driver or non-driver. Further, input from vehicle instruments such as the steering wheel or indicators may be used to correlate with the detected visual attention to improve the classification.

### INTERPRETATION

The term “infrared” is used throughout the description and specification. Within the scope of this specification, infrared refers to the general infrared area of the electromagnetic spectrum which includes near infrared, infrared and far infrared frequencies or light waves.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “controller” or “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of exemplary embodiments of the disclosure, various features of the disclosure are sometimes grouped together in a single embodiment, Fig., or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, electrical or optical contact, or that two or more elements are not in direct contact with each other but yet still co-operate or interact with each other.

Embodiments described herein are intended to cover any adaptations or variations of the present invention. Although the present invention has been described and explained in terms of particular exemplary embodiments, one skilled in the art will realize that additional embodiments can be readily envisioned that are within the scope of the present invention.

1. A method of detecting use of a mobile device located within a vehicle by a driver of the vehicle, the method comprising:
receiving a sequence of images of at least the driver's face or facial features captured from a camera;
processing the sequence of images to determine visual attention of the driver based on detected head and/or eye movements of the driver over a period of time;
detecting mobile device use events within the period of time in which a user interacts with a mobile device that is located within the vehicle;
determining a mobile device region based on the visual attention of the driver within one or more regions where mobile devices are typically used by vehicle drivers;
determining a temporal correlation of the visual attention of the driver within the mobile device region with the mobile device use events over the period of time; and
determining that the driver is using the mobile device if the determined temporal correlation is greater than a threshold correlation coefficient.

2. The method according to claim 1 wherein the mobile device use events include detected movement of the mobile device by an in-built inertial measurement unit.

3. The method according to claim 1 wherein the mobile device use events include touches at a user interface of the mobile device.

4. The method according to claim 1 wherein the camera is a vehicle-mounted camera.

5. The method according to claim 4 wherein the mobile device includes a mobile device camera and the mobile device use events include head and/or eye movement towards the mobile device measured from images captured by the mobile device camera.

6. The method according to claim 1 wherein the visual attention is derived from measurements of one or more of eye gaze direction, head pose, eyelid closure or pupil movement.

7. The method according to claim 1 wherein detecting mobile device use events includes detecting driver head and/or eye movements from one or more cabin cameras positioned within a cabin of the vehicle.

8. (canceled)

9. The method according to claim 1 wherein detecting mobile device use events includes detecting the mobile device in one or more of the images in a location proximal to the driver.

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. A method of characterizing a subject as a vehicle driver, the method including the steps of:
receiving images of a subject in a vehicle from a camera of a mobile device;
processing the captured images to determine visual attention direction of the imaged subject;
determining a probable forward road region from the behaviour of the visual attention direction over time; and
determining, based on the behaviour of the visual attention direction towards the forward road region over time, whether the subject is the driver of the vehicle or a passenger.

42. The method according to claim 41 including the step of detecting that the vehicle is in motion.

43. The method according to claim 41 wherein the step of determining whether the subject is the driver includes characterizing the visual attention direction into regions of interest including a forward road region corresponding to the road in front of the vehicle and a mobile device region corresponding to a location of the mobile device.

44. The method according to claim 42 including the step of measuring an amount of time that the subject is paying attention to the forward road region over a predetermined time window.

45. A system adapted to perform a method according to claim 1.

46. (canceled)
